(19) United States
(12) Patent Application Publication
(10) Pub. No.: US 2008/0316635 A1
(43) Pub. Date: Dec. 25, 2008

(54) Deriving servo PES from DC erased bursts in perpendicular recording

(75) Inventors: Kiseok Moon, Pleasanton, CA (US); Carl Xiaodong Che, Saratoga, CA (US); Yawshing Tang, Saratoga, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/820,992

(22) Filed: Jun. 20, 2007

(51) Int. Cl. G11B 21/02

(52) U.S. Cl. 360/75

(57) ABSTRACT

A hard disk drive with a disk that has DC erased servo bursts. The DC erased servo bursts are read by a perpendicular recording head that produces a relatively square burst signal. The burst signal is used determine a position error signal and center the head on a track of the disk.

### BACKGROUND OF THE INVENTION

1. Field of the Invention

The present invention relates to a servo field on a disk of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Data is stored on tracks located on the surfaces of the disks. Each track typically contains a plurality of sectors. A sector may have a servo field that is used to center the head on the track. The servo field contains a number of spaced apart servo bursts. The amplitude of the servo bursts will vary depending on the position of the head relative to each burst. A position error signal is generated from the servo bursts. The position error signal is used to center the head on the track.

The servo burst are typically written with a servo writer during the manufacturing process of the disk drive. The burst are created by magnetic transitions in the disk material. It is difficult to accurately write servo burst onto a disk surface with magnetic transitions. Additionally, the magnetic transitions create unwanted noise.

There have been developed disk media that includes concentric grooves that separate the various tracks of the disk. The grooves separate areas of magnetic material. The grooves themselves have no or little magnetic material. The inclusion of grooves reduces or eliminates cross-talk between tracks. This type of disk media is also known as a patterned disk. It is difficult to write servo information on a patterned disk because the written servo burst must be accurately aligned with the magnetic material of the tracks. It would be desirable to create servo information on a pattern disk without writing conventional servo burst on the disk.

### BRIEF SUMMARY OF THE INVENTION

A hard disk drive with a disk that has at least one servo field on a track. The servo field includes at least one DC erased servo burst. The disk drive also includes a perpendicular recording head and a controller. The controller causes the perpendicular recording head to read the DC erased servo burst and use the DC erased servo burst to position the head on the track.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is an illustration showing a servo pattern;

FIG. 5 is a graph showing A and B servo signals as a function of track position and location;

FIG. 6 is a graph showing a position error signal and servo signals as a function of track position.

### DETAILED DESCRIPTION

Disclosed is a hard disk drive with a disk that has DC erased servo burst. The DC erased servo burst are read by a perpendicular recording head that produces a relatively square burst signal. The burst signal is used determine a position error signal and center the head on a track of the disk.

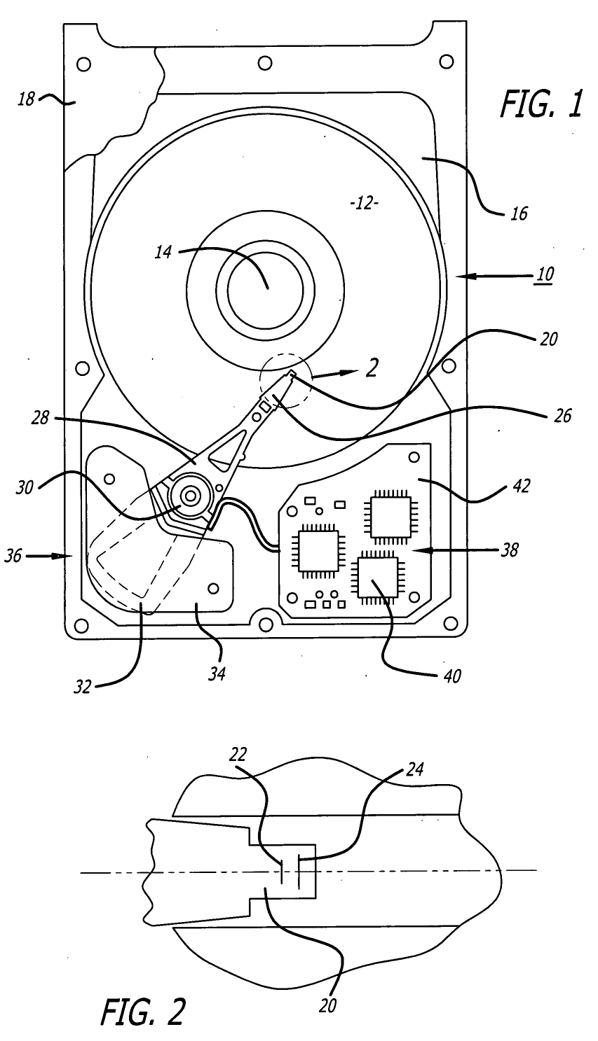

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12. The disks 12 may be either continuous media or patterned media. A patterned media includes a plurality of grooves (not shown) that separate tracks of magnetic material. A continuous media contains no such grooves.

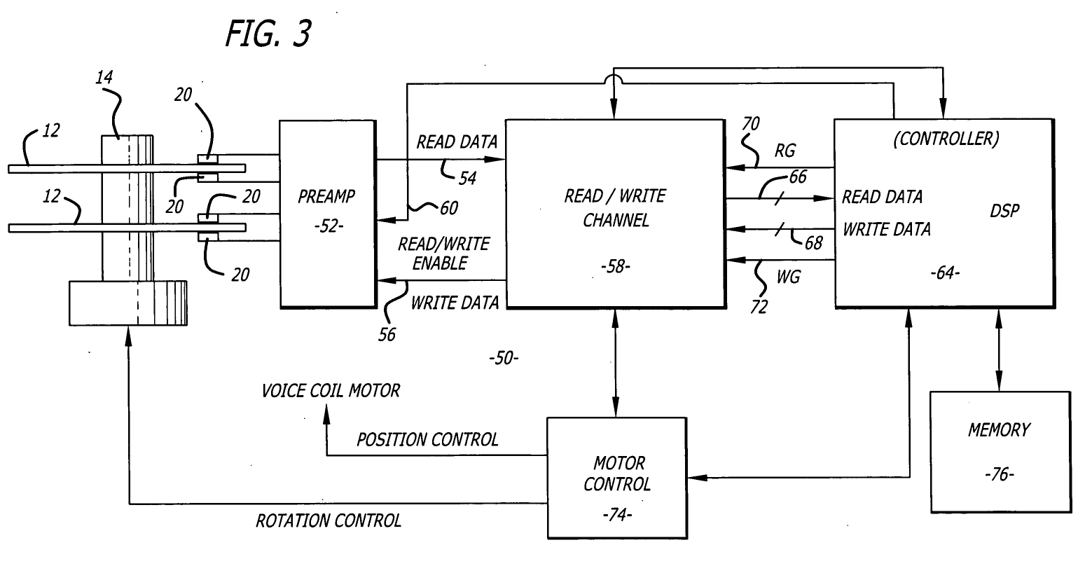

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux. The write element 22 can magnetize the disk in a vertical direction. Vertical magnetization is commonly referred to as perpendicular recording.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the instructions to operate the controller and disk drive. Alternatively, the controller may have embedded firmware to operate the drive.

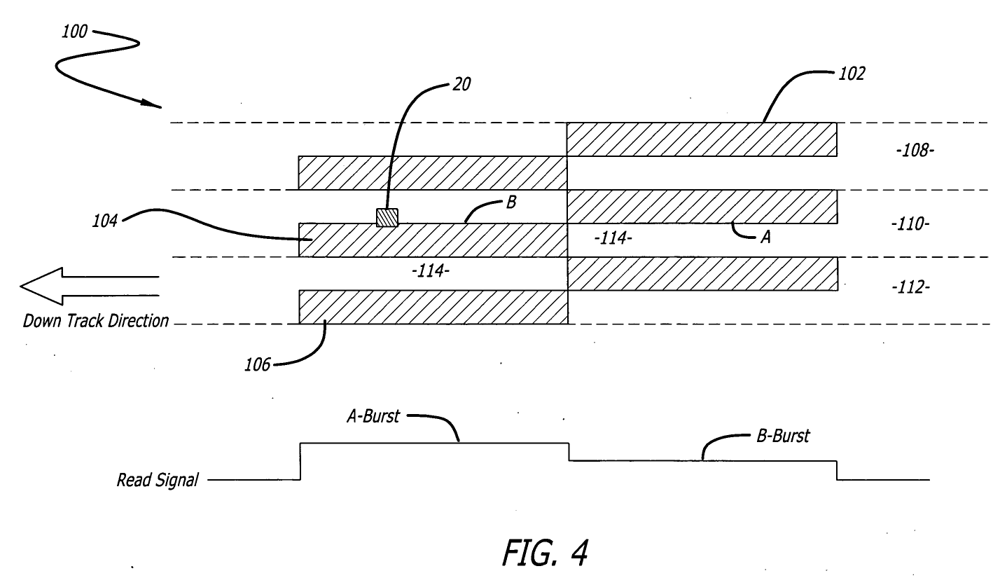

FIG. 4 shows a servo pattern 100 on a disk. The servo pattern 100 may include a plurality of servo fields 102, 104 and 105. Each servo field 102, 104 and 106 is part of a track 108, 110 and 112, respectively. The servo fields may each include an A DC erased servo burst and a B DC erased servo burst. The servo bursts are created by applying a DC voltage to the write element of the head. Such a technique is commonly referred to as a DC erase. As an alternate embodiment the servo burst may be magnetized with a very low frequency signal, on the order of one or two cycles per burst.

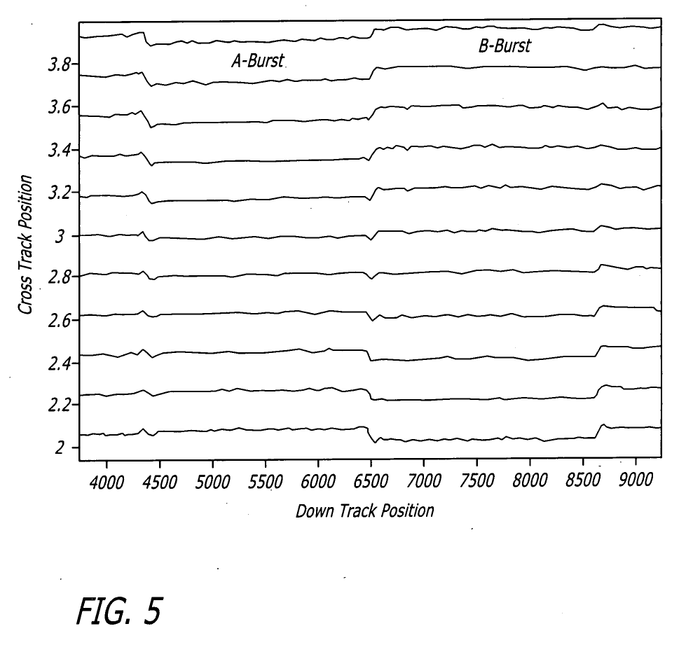

Perpendicular recording heads will produce a relatively square read signal when sensing a DC erased region of a disk. Consequently, utilizing DC erased servo bits will produce square servo signals which are easier to process. The position of the head 20 relative to the A and B servo burst will determine the amplitude of the burst signals. In the example shown the head is centered more over the A servo burst than the B servo burst. Consequently, the A burst signal has a higher amplitude than the B burst signal. FIG. 5 shows A and B burst signals as a function of track position and track location.

Patterned media typically includes a plurality of magnetic dots separated by non-magnetic material. To achieve the desired result it is desirable to have continuous bands of magnetic material in the servo burst areas. A continuous band of magnetic material that is DC erased will produced the desired square read signal. A servo with a pattern of magnetic dots would produce a read signal with an alternating waveform.

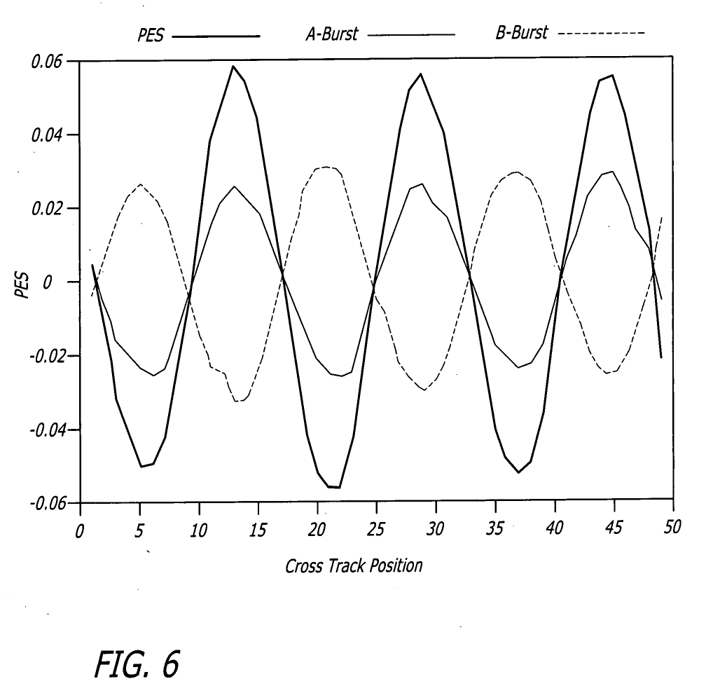

The A and B burst signals are used to determine a position error signal (“PES”). The PES is used to move and position the head onto the center of the track. FIG. 6 shows a PES along with A and B servo signals.

The servo patterns can be created within the disk drive by DC erasing regions of the disk. Using DC erased servo burst will reduce the noise created by servo burst of the prior art which have magnetic transitions.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, when used on a continuous media regions 114 between the A and B servo bursts can be AC erased. The polarity of the servo burst can be alternated so that the net magnetic field will be zero in the cross direction. Alternatively, the servo bursts and adjacent regions 114 can have alternate polarity so that only an A servo burst is required.

What is claimed is:

1. A hard disk drive, comprising:
a disk that has at least one servo field on a track, said servo field includes at least one DC erased servo burst;
a perpendicular recording head coupled to said disk; and,
a controller coupled to said perpendicular recording head, said controller causes said perpendicular recording head to read said DC erased servo burst and use said DC erased servo burst to position said perpendicular recording head on said track.

2. The disk drive of claim 1, wherein said servo field includes an A DC erased servo burst and a B DC erased servo burst.

3. The disk drive of claim 2, wherein said controller determines a position error signal from said A and B DC erased servo bursts.

4. The disk drive of claim 2, wherein said servo field includes an AC erased region between said A and B DC erased servo bursts.

5. The disk drive of claim 2, wherein said servo field includes an AC erased region between said A and B DC erased servo bursts.

6. The disk drive of claim 1, wherein said disk is a pattern media.

7. A method for positioning a head relative to a track of a disk in a hard disk drive, comprising:
reading at least one DC erased servo burst on a track of a disk;
determining a position error signal from the DC erased servo burst; and,
moving the head relative to the track based on the position error signal.

8. The method of claim 7, wherein an A DC erased servo burst and a B DC erased servo burst are read.

9. The method of claim 7, wherein the disk is a pattern media.

10. A method for writing a servo pattern onto a disk of a hard disk drive, comprising:
writing a plurality of servo fields onto a disk, each field including at least one DC erased servo burst.

11. The method of claim 9, wherein an A DC erased servo burst and a B DC erased servo burst are written onto the disk.

12. The method of claim 11, further comprising writing an AC erased region between the A and B DC erased servo bursts.

13. The method of claim 10, wherein the disk is a pattern media.

14. The method of claim 10, further comprising writing an AC erased region adjacent to the DC erased servo burst.
